(19) United States
(12) Patent Application Publication
(10) Pub. No.: US 2002/0008170 A1
(43) Pub. Date: Jan. 24, 2002

(54) Shredder

(76) Inventor: Anthony Turner, Warwickshire (GB)

Correspondence Address: Matthew R. Schantz, Woodard, Emhardt, Naughton, Moriarty and McNett, Bank One Center/Tower, 111 Monument Circle, Suite 3700, Indianapolis, IN, 46204-5137, US

(21) Appl. No.: 09/875,557

(22) Filed: Jun. 6, 2001

(30) Foreign Application Priority Data
Jun. 6, 2000 (GB) US 0 013 623.4

(51) Int. Cl. B02C 18/22

(52) U.S. Cl. 241/101.76

(57) ABSTRACT

A shredder (10) for brushwood comprises a shaft (52) which carries first and second sets (54, 56) of cutters (58). Each set of cutters (54, 56) is arranged around the shaft (52) along respective helical paths. The first set (54) of cutters (58) is arranged to feed out material towards one end of the shaft. The second set (56) of cutters (58) is arranged to feed cut material towards the other end of the shaft.

The invention relates to a shredder for brushwood or other organic waste and particularly to, but not exclusively limited to, a shredder for brushwood or other organic waste mounted on a trailer to be towed behind the vehicle.

Shredders for shredding brushwood of other organic waste are known and are generally used by tree surgeons and local authority operatives to dispose of all forms of organic waste such as cuttings from trees and other plants. Material shred by the shredder can then be used as a mulch or can be composted for reincorporation into the soil.

Most shredder machines operate on a flail principal. That is to say, individual flail cutters are freely pivoted to a shaft which is rotated at a substantial speed to cause the cutters to fly out centrifugal to the shaft. The waste material is then fed into the path of the cutters. The power requirement for those machines is high and the noise level is also high.

An alternative form of shredder is disclosed in our co-pending European Patent Application Number 0903182. That shredder has a shaft carrying a helical array of cutting/shredding discs.

There is a requirement for shredders having increased capacity to handle larger volumes of material.

It is an object of the invention to provide an improved shredder.

According to the invention there is provided a shredder for brushwood or other organic waste comprising a shaft having first and second sets of cutters, each set of cutters being arranged around the shaft along respective helical paths so as to feed cut material along the shaft, the first set being arranged to feed cut material towards one end of the shaft and the second set being arranged to feed cut material towards the other end of the shaft.

In that way a larger capacity machine can be provided since twice the volume of material can be inserted into the shredder described above and the cut material is fed in opposite directions towards the ends of the shaft for expulsion from the shredder.

Preferably the first set of cutters feeds cut material from the centre of the shaft towards said one end and the second set feeds material from the centre of the shaft towards said other end. In an alternative embodiment, the first set of cutters has an outer end towards said one end of the shaft and an inner end towards the centre of the shaft, the second set of cutters has an outer end towards said other end of the shaft and an inner end towards the centre of the shaft and the inner ends of the first and second sets overlap slightly. In a still further embodiment, a central cutter may be provided to slice material hat bridges the centre of the shaft

Expulsion means may be provided at each end of the shaft. Preferably each expulsion means comprises at least one generally radial by extending web carried by the shaft arranged in a chamber at respective ends of the shaft arranged so as to provide an airflow to exhaust tangentially from the chamber so as to expel the shredded material. An elongate exhaust tube may be provided from the chamber so as to direct the exhausted cut material away from the shredder. The exhaust tube is preferably rotatable. The exhaust tube may be tiltable up and down.

The shredder may further include a feed rotor which is arranged to pull material into the shredder and force it in the direction of the cutters. The feed rotor preferably includes a series of teeth on the periphery thereof The feed rotor may be moveable from a non-feed position to a feed position.

The shredder may include a hopper for loading material to be shredded. In such a case, the feed rotor is arranged at one end of the hopper. The feed rotor in that case is moveable from a position above the material to be cut in the hopper to a position engaging the material to be cut. The hopper may include a sensor to determine the presence of a “non-suitable object”. Examples of “non-suitable object” would be material which is likely to damage the shredder such as concrete or metal or the limbs of an operator.

The shredder is preferably located on a trailer which can be hitched behind a vehicle. The trailer preferably carries a motor for driving the drive shaft and, where provided, the feed rotor.

One embodiment of shredder will now be described in detail by way of example and with reference to the accompanying drawings, in which:

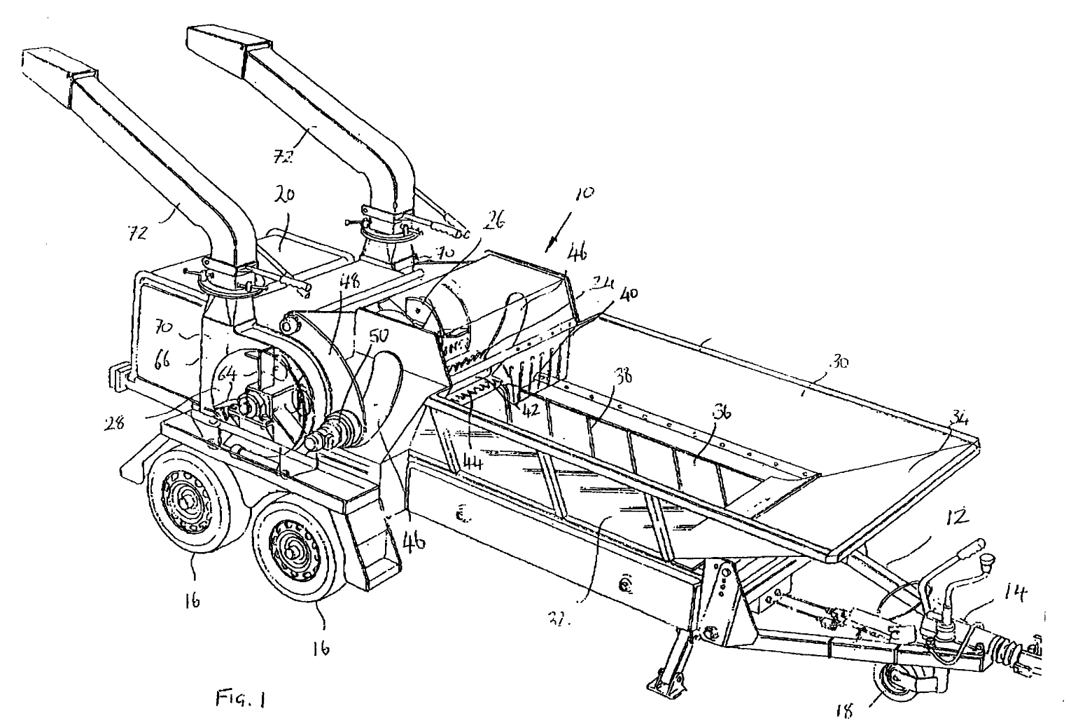

FIG. 1 is a perspective view of a shredder in accordance with the invention, and

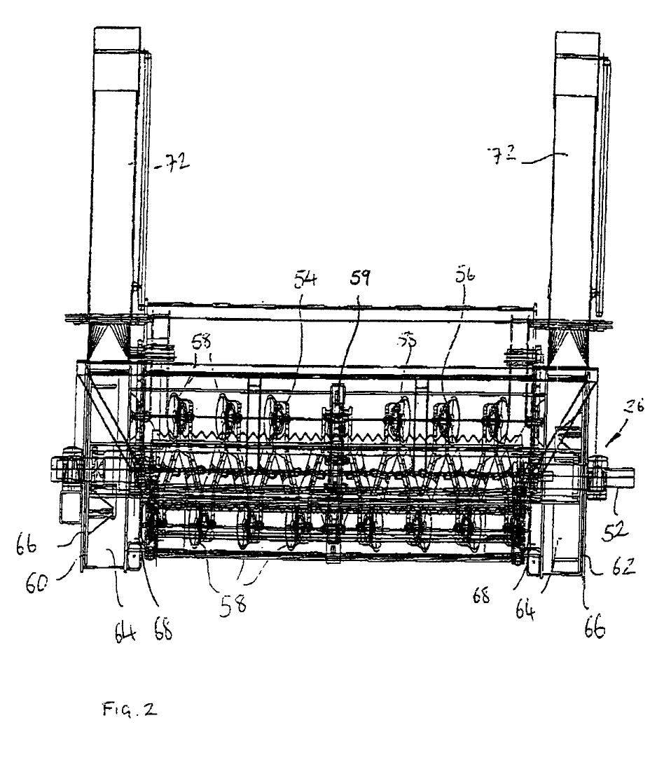

FIG. 2 is an elevation of part of the shredder of FIG. 1 with the hopper removed for clarity.

In FIG. 1 the shredder assembly 10 forms part of a trailer 12 intended To be towed behind a vehicle to an intended place of use. The trailer 12 comprises a conventional hitch 14, trailer wheels 16 and a jockey wheel 18 for use in manoeuvring the trailer when disconnected from the vehicle. The trailer 18 also carries a drive engine 20 with associated fuel tank. coolant system, starter motor gearing etc. (not shown). The motor 20 drives the shredder assembly 10.

The shredder assembly 10 comprises a hopper 22, a feed mechanism 24, a shredder mechanism 26 and an exhaust assembly 28. The hopper 22 comprises two slanted side walls 30, 32 and a slanted end wall 34. Side and end walls, 30, 32, 34 define an open base and open other end The end wall 34 is arranged forward most of the trailer relative to the rest of hopper. The “free ends” of side walls 30, 32 abut an enclosure for the feed and shredder mechanisms,

The feed mechanism 24 comprises a conveyor belt 36 arranged beneath the open base of the hopper 22. The conveyor 36 has chevron shaped ribs 38 formed on the surface thereof. The conveyor 36 is driven to feed material loaded thereon towards the open end of the hopper 22. A curtain 40 comprising slats of resilient material such as rubber is arranged across the open mouth of the enclosure for the feed rotor and shredder mechanism. The curtain 40 is provided to prevent cut material being thrown back towards the hopper from the shredder.

Feed mechanism 24 further comprises a feed rotor 42. The feed rotor 42 comprises a driven shaft carrying four sets of teeth 44 running longitudinally of the shaft and regularly equally spaced about the periphery thereof. The feed rotor 42 is located in guide tracks 46, the ends of the rotor 42 extending through the guide tracks 46 and being carried by pivotal arms 48. One end of the rotor 42 is connected to a drive 50, such as a hydraulic drive. The arms 48 are pivotally mounted at a point remote from the feed rotor 42 so as to enable up and down movement of the rotor 42 along the guide track 46 by pivotal movement of the arms 48. The arms 48 may be positioned by means of hydraulics to attain certain positions. Alternatively, the position of the arms may be adjusted manually. Still further, the rotor may be arranged simply to “float” up and down the guide track 46 so as to accommodate different sizes and volumes of material to be cut The weight of the rotor itself acts with sufficient downward force to allow feeding to occur when rotating of the feed rotor commences.

The shredder mechanism 26 is best illustrated in FIG. 2. The shredder mechanism 26 comprises shaft 52 which carries first and second sets 54, 56 of cutters 58. The shaft 52 further carries flywheels 60, 62 at opposite ends hereof. The flywheels 60, 62 include radial vanes 64 as shown in FIG. 1.

The cutters 58 in the first set 54 are arranged in a helical pattern around the shaft whereby rotation of the shaft in a clockwise direction as viewed in FIG. 1 will feed cut material cut by the cutters 58 from the middle of the shaft 52 towards the end of the shaft which carries the flywheel 60. Likewise, that same rotation will cause the cutters 58 in the second set 56 of cutters to cut material and to feed the cut material to the end of the shaft 52 which carries flywheel 62. In the embodiment illustrated there are sixteen cutters 58 in each set. The cutters 58 are substantially similar to those described in EP-A-0903182. A central cutting blade 59 is mounted on the shaft 52 between the first and second sets 54, 56 of cutters 58. The central cutting blade cuts lengthy material which bridges the two sets of cutters.

The exhaust assembly 28 comprises the radial vanes 64 carried by the flywheel, 60, 62 on the shaft 52 of the shredder mechanism. The vanes 64 are enclosed within a chamber 66. The chamber 66 has an inlet 68 Through which cut material from the shredder mechanism 26 is received and an outlet 70 is arranged tangentially of the path of the radial vanes 64 through which cut material is exhausted. The exhaust assembly 28 further comprises exhaust tubes 72 which are connected to the exhaust outlet 70 of the respective exhaust enclosure 66. The exhaust tubes 72 are inclined towards the horizontal from the exhaust outlet 70. The tubes 72 are rotatable from side to side and are also preferably pivotable up and down to enable more accurate exhausting of shred material

In use, the material to be shred is loaded into the hopper 22 and the conveyor belt 36 is activated. The conveyor 36 forces material towards the feed rotor 42 which “floats” on the surface of the incoming woody material. The rotor 42 is driven in rotation and the teeth 44 separate sections of infed material and pass those sections to the shredder mechanism 26. The shredder mechanism shreds the material by means of the cutters 58 and the helical arrangements of the cutters 58 feeds the shred material towards the end of the shaft 52 of the shredder mechanism 26. The rotation of the shaft 52 also drives The vanes 64 of the exhaust assembly which blow the cut material out of the shredder through the exhaust tube 72.

By way of example, the shredder 10 may have a shredding width of 400 mm, 600 mm, 850 mm or 1400 mm. Alternatively to the exhaust assembly 28, the cart and feed material may drop onto a conveyor which can be arranged to convey the material to a container.

The present invention provides a large capacity shredding machine which is not prone to blockage and which does not require larger, and thus more expensive, shredder parts.

What is claimed is:

1. A shredder for brushwood or other organic waste comprising a shaft having first and second sets of cutters, each set of cutters being arranged around the shaft along respective helical paths so as to feed cut material along the shaft, the first set being arranged to feed cut material towards one end of the shaft and the second set being arranged to feed cut material towards the other end of the shaft.

2. A shredder for brushwood according to claim 1 in which the first set of cutters feeds cut material from the center of the shaft towards said one end and the second set feeds material from the center of the shaft towards said other end.

3. A shredder for brushwood according to claim 1 in which the first set of cutters has an outer end towards said one end of the shaft and an inner end towards the center of the shaft, the second set of cutters has an outer end towards said other end of the shaft and an inner end towards the center of the shaft and the inner ends of the first and second sets overlap slightly.

4. A shredder for brushwood according to claim 1 further comprising a central cutter to slice material that bridges the center of the shaft.

5. A shredder for brushwood according to claim 1 further comprising expulsion means at each end of the shaft.

6. A shredder for brushwood according to claim 5 in which each expulsion means comprises at least one generally radial by extending web carried by the shaft arranged in a chamber at respective ends of the shaft arranged so as to provide an airflow to exhaust tangentially from the chamber so as to expel the shredded material.

7. A shredder for brushwood according to claim 6 further comprising an elongate exhaust tube is provided from the chamber so as to direct the exhausted cut material away from the shredder.

8. A shredder for brushwood according to claim 7 in which the exhaust tube is rotatable.

9. A shredder for brushwood according to claim 7 in which the exhaust tube is tiltable up and down.

10. A shredder for brushwood according to claim 1 further comprising a feed rotor which is arranged to pull material into the shredder and force it in the direction of the cutters.

11. A shredder for brushwood according to claim 10 in which the feed rotor includes a series of teeth on the periphery thereof.

12. A shredder for brushwood according to claim 10 in which the feed rotor is moveable from a non-feed position to a feed position.

13. A shredder for brushwood according to claim 10 further comprising a hopper for loading material to be shredded, the feed rotor is arranged at one end of the hopper.

14. A shredder for brushwood according to claim 13 in which the hopper includes a sensor to determine the presence of a “non-suitable object.”

15. A shredder for brushwood according to claim 1 further comprising a hopper for loading material to be shredded.

16. A shredder for brushwood according to claim 13 in which the feed rotor is moveable from a position above the material to be cut in the hopper to a position engaging the material to be cut.

17. A shredder for brushwood according to claim 13 in which the hopper includes a sensor to determine the presence of a “non-suitable object.”

18. A shredder for brushwood according to claim 1 in which the shredder is located on a trailer which can be hitched behind a vehicle.

19. A shredder for brushwood according to claim 18 in which the trailer carries a motor for driving the shaft and, where provided, the feed rotor.
